(19) United States
(12) Patent Application Publication
(10) Pub. No.: US 2009/0282972 A1
(43) Pub. Date: Nov. 19, 2009

(54) COMPOSITE PISTON FOR A MOTOR VEHICLE TRANSMISSION

(75) Inventor: Henning Schmidt, Ahrensburg (DE)

Correspondence Address: SALIWANCHIK LLOYD & SALIWANCHIK;A PROFESSIONAL ASSOCIATION, PO Box 142950, GAINESVILLE, FL, 32614, US

(73) Assignee: Dichtungstechnik G. Bruss GmbH & Co. KG, Hoisdorf (DE)

(21) Appl. No.: 12/467,871

(22) Filed: May 18, 2009

(30) Foreign Application Priority Data
May 19, 2008 (DE) 10 2008 024 163.6

(51) Int. Cl. F16J 9/00

(52) U.S. Cl. 92/248

(57) ABSTRACT

A composite piston (10) for a motor vehicle transmission comprises a support body (14) and at least one rotationally symmetric annular seal comprising an elastomer sealing lip (16, 17) interacting in a sealing manner with a component (11, 12) forming a cylindrical sliding surface (21, 23), wherein the composite piston (10) can be displaced translationally relative to the component (11, 12) forming the cylindrical sliding surface. The annular seal comprises an elastomer annular bead (20, 22) displaced axially relative to the sealing lip (16, 17), wherein the annular bead is arranged to have a distance d1, d2 from the sliding surface (21, 23) in the non-loaded state larger than or equal to zero.

### RELATED APPLICATION

The application claims priority under 35 U.S.C. §119(e) of German Patent Application No. DE 102008024163.6, filed on May 19, 2008, which is hereby incorporated by reference in its entirety.

### BACKGROUND OF INVENTION

Composite pistons for a motor vehicle transmission are known from DE 199 15 022 B4 and DE 202 09 125 U1. The pressure portion occurring at the annular gap is transmitted to the piston via the annular seals as an axial force. This axial force needs to be supported by the piston in a suitable manner, where the mechanical load capacity of an elastomer seal might be exceeded at common pressures unless the constructional configuration is very accurate. An eccentric displacement can already occur when mounting such a piston, as the reset force of the sealing lips in particular in the pre-loaded state is not always sufficient for a complete centering of the piston.

In rotating applications the reset force of the sealing lips is not sufficient for compensating the occurring centrifugal forces so that the piston abuts on the sliding surface. The eccentricity causes the sealing gap on one side to possibly increase to the twice, resulting in a severe reduction of the mechanical load capacity of the sealing lip. The sealing lip may possibly break off in the event of overload so that the functioning of the piston is no longer guaranteed. Therefore, a perfect centering of the piston is a precondition for its functioning also at high engine speeds as they often occur for example in vehicle transmissions.

However, also in non-rotating applications it may possibly not be permissible that the weight of the piston is transmitted via the sealing lips if for example a non-permissible eccentricity would occur due to a heavy weight of the piston.

U.S. Pat. No. 2,386,668 discloses a piston of a pressure differential operated, double acting motor.

US 2008 0289489 A1 discloses a composite piston unit comprising a shift rod and two control pistons securely connected with respectively one end of the shift rod.

DE 37 10 403 A1 discloses a piston unit designed to be pressurized from both sides by a pneumatic medium, and comprises a clamping flange and a sealing element attached to the clamping flange.

### BRIEF SUMMARY

Embodiments of the invention provide a functionally reliable composite piston, in which an overload of the sealing lip as a result of an exceedingly large eccentricity of the piston is avoided.

Embodiments of the invention incorporate a support body; and at least one annular seal, wherein each of the at least one annular seal comprises: a sealing lip interacting in a sealing manner with a component forming a cylindrical sliding surface, wherein the composite piston can be displaced translationally relative to the component forming the cylindrical sliding surface; and an annular bead displaced axially relative to the sealing lip and arranged to have a distance d1 from the sliding surface in a non-loaded state, where d1 is greater than or equal to zero. Under radial load the annular bead comes in contact with the sliding surface and the sealing lip is mechanically relieved as a result of introducing forces into the sliding surface via the annular bead. Embodiments of the invention realizes a functional separation by completely uncoupling the sealing element from the guiding element: the annular bead serves for absorbing the radial forces generated by the piston and for introducing the same into the sliding surface so that the flexibility of the sealing lip is not affected adversely and the sealing function is therefore optimally guaranteed. Because of the annular bead according to the invention an optimal centering of the piston is therefore already realized during the assembly.

In pistons inserted into rotating components the annular bead helps to reduce an eccentricity due to the imbalance of the piston.

Preferably the annular bead is radially supported on the support body over its total axial length such that the annular bead can essentially completely absorb and transmit the radial forces exerted by the piston. Through this feature the annular bead is distinguishable from an additional sealing lip or protecting lip.

Advantageously, at least one axial gap, and preferably a plurality of axial gaps, in particular evenly distributed over its circumference, is provided in the annular bead. These allow oil to reach the seal also from the low pressure side in order to prevent the bead from obstructing the lubrication of the sealing lip. The gap further reduces the risk of the piston being clamped, since additional volume is provided to which the elastomer can pass for example upon excessive expansion.

The annular bead preferably is dimensioned in such a way that under pressure load a radial deformation occurs. Thereby, the annular bead comes in contact with the sliding surface earlier and the possible eccentricity of the piston is further reduced.

### BRIEF DESCRIPTION OF DRAWINGS

In the following, the invention is described in more detail on the basis of preferred embodiments with reference to the attached figures, wherein:

FIG. 1 shows a partial longitudinal cut through a composite piston;

FIG. 2 shows a top view of a composite piston according to the invention from a direction perpendicular to the central axis;

FIG. 3 shows a cross-sectional view of a composite piston according to the invention from a direction parallel to the central axis; and

FIG. 4 shows a cross-sectional view of another embodiment of a composite piston according to the invention from a direction parallel to the central axis.

### DETAILED DISCLOSURE

Embodiments of the invention relate to a composite piston for a motor vehicle transmission comprising a support body and at least one annular seal connected thereto with an elastomer sealing lip. Such pneumatically or hydraulically actuated composite pistons are for example used in automatic vehicle transmissions, in particular for shifting multi-disc clutches or brake bands, as well as in hydraulically or pneumatically actuated servo mechanisms of motor vehicles.

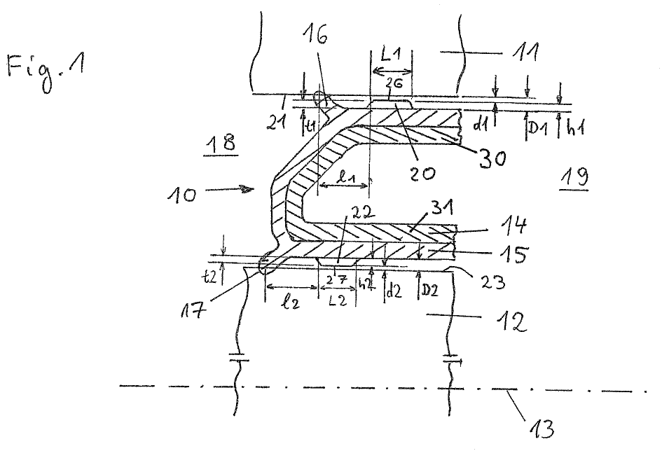

The composite piston 10 shown in FIG. 1 can be displaced translationally along the central axis 13 between a cylinder 11 and a shaft 12. The composite piston has an annular form around the central axis 13 of the cylinder 11 and the shaft 12. The composite piston 10 includes an annular support body 14 having for example a U-profile, as can be seen from FIG. 1. The support body 14 can be made of metal, in particular of sheet steel, or of a plastic material. The composite piston 10 preferably consists of two components only, i.e. the uniform or rather one-piece support body 14 and the uniform or rather one-piece elastomer layer 15 vulcanized to the support body 14. The thickness of the rubber layer 15 is in the range of some 1/10 mm.

The uniform elastomer layer 15 is vulcanized to the support body 14 on the outer surface of the U-profile. The elastomer layer 15 forms an outer dynamic annular sealing lip 16 at the outside of an outer bracket 30 of the U-form support body 14 for dynamically sealing the annular gap between the cylinder 11 and the outer diameter of the composite piston 10. The elastomer layer 15 furthermore forms an inner dynamic annular sealing lip 17 at the inside of an inner bracket 31 of the U-form support body 14 for dynamically sealing the annular gap between the shaft 12 and the inner diameter of the composite piston 10. As a result of this sealing, loading the composite piston 10 with a hydraulic or pneumatic pressure on the pressure side 18 causes a translational displacement of the composite piston 10 towards the low pressure side 19. The piston 10 is preferably unidirectional, i.e. designed to be pressurized by a pressure medium on one side 18, only, and may therefore be distinguished from bidirectional pistons designed to be pressurized by a pressure medium on both sides.

The elastomer layer 14 forms an annular bead 20 on the low pressure side of the sealing lip 16 at a distance l1. The annular bead 20 comprises a cylindrical contact surface 26 for interacting with the sliding surface 21 having a small distance d1 from the cylindrical inner surface 21 of the component 11. As can be seen from FIG. 1, the annular bead 20 is radially supported over its total axial length L1 by the support body 14 without any free gap in between. In the event of occurrence of an eccentricity of the composite piston 10 relative to the cylinder component 11 the annular bead 20 abuts against the sliding surface 21 and introduces the radial forces effecting the eccentricity into the component 11, whereby the eccentricity is limited to approximately the distance d1. This implies a considerable improvement compared to the prior art without the annular bead 20, where eccentricity of the setting piston 10 can possibly occur up to approximately the width D1 and D2 respectively of the annular gap between the elastomer layer 14 and the sliding surface 21 of the cylinder component 11, whereby the sealing lip 16 is exposed to extensive load and the sealing function can be affected adversely.

The distance l1 preferably is in the range of 1 mm to 10 mm, more preferably in the range of 1 mm to 4 mm and for example is 2.5 mm. The distance d1 preferably is less than 0.4 mm, more preferably less than 0.3 mm, for example approximately 0.2 mm. The axial length L1 of the annular bead 20 preferably is in the range of 1 mm to 10 mm, more preferably in the range of 1 mm to 3 mm. The radial height h1 of the annular bead 20 above the elastomer layer preferably is in the range of 0.1 mm to 1 mm, more preferably in the range of 0.1 mm to 0.4 mm and for example is approximately 0.2 mm. The depth t1 of the depression 21 formed between the sealing lip 16 and the annular bead 20 preferably is at least 0.1 mm.

The elastomer layer forms a similar annular bead 22 on the low pressure side of the sealing lip 17 at a distance l2, which annular bead has a small distance d2 from the cylindrical outer surface or rather sliding surface 23 of the component 11. The statements relating to the outer annular bead 20, in particular to the dimensions d1, D1, l1, L1, h1 and t1, also apply to the inner annular bead 22 and the corresponding dimensions d2, D2, l2, L2, h2 and t2.

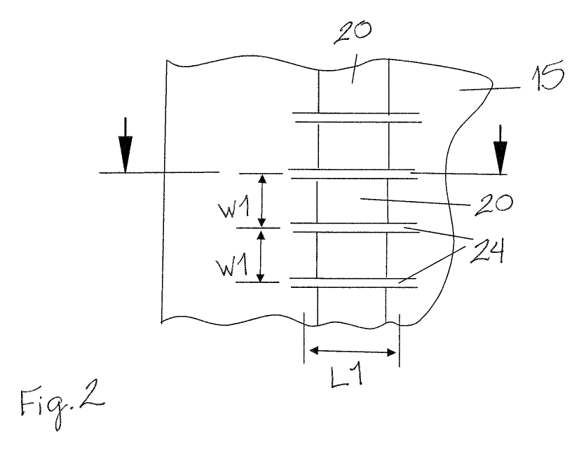

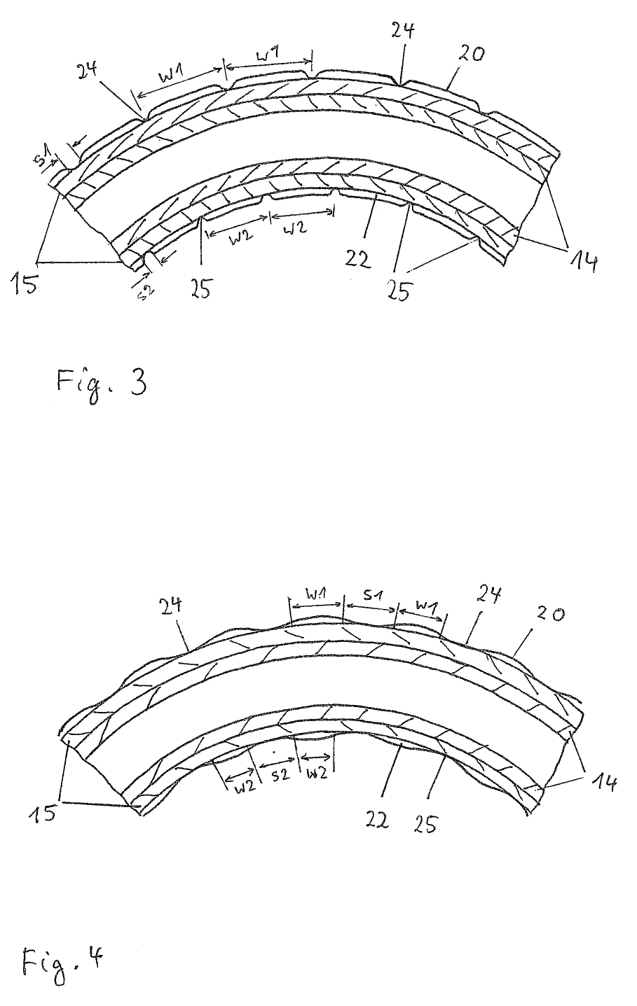

Axial gaps 24 and 25 respectively are provided in the annular beads 20, 22, which gaps preferably are evenly distributed over the circumference of the composite piston 10, as can be seen from FIGS. 2 and 3. The gaps 24, 25 allow oil to reach the sealing lips 16, 17 from the low pressure side 19 of the composite piston 10 in order to prevent the annular beads 20, 22 from obstructing the lubrication. The relation of the width s1 of the gap 24 to the width w1 of the annular bead preferably is in the range of 1:1 to 1:20, more preferably in the range of 1:5 to 1:10. The same applies to the corresponding relation of s2 to w2 of the gaps 25 in the inner annular bead 22.

The unit of composite piston 10 and cylindrical housing 11 and shaft 12 respectively can have an overall rotary configuration. In this kind of application the annular beads 20, 22 help to reduce an eccentricity effected due to the imbalance of the piston 10. In another application the unit of composite piston 10 and cylindrical housing 11 and shaft 12 respectively can have a non-rotary configuration.

In the preferred embodiment shown in FIG. 4 the annular beads 20, 22 are designed to be sinusoidal along the circumference of the piston. The following advantages result therefrom. With the annular bead 20, 22 having a sinusoidal contour the tool can be used by only being clamped once without re-clamping. Moreover, the path-reset-force-characteristic takes a progressive course. Finally, an elasto-hydrodynamic lubricating oil film can develop during a possible relative movement of the piston in the circumferential direction in relation to the shaft 12 and the cylinder 11 respectively.

The annular beads 20, 22 can be located on the high pressure side of the sealing lip 16 and 17, respectively.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

What is claimed is:

1. A composite piston for a motor vehicle transmission, comprising:
a support body; and
at least one annular seal, wherein each of the at least one annular seal comprises:
a sealing lip interacting in a sealing manner with a component forming a cylindrical sliding surface, wherein the composite piston can be displaced translationally relative to the component forming the cylindrical sliding surface; and
an annular bead displaced axially relative to the sealing lip and arranged to have a distance d1 from the sliding surface in a non-loaded state, where d1 is greater than or equal to zero.

2. The composite piston according to claim 1, wherein the sealing lip is an elastomer sealing lip, wherein the annular bend is an elastomer annular bead.

3. The composite piston according to claim 1, wherein each of the at least one annular seal is rotationally symmetric.

4. The composite piston according to claim 1, wherein the annular bead is radially supported by the support body.

5. The composite piston according to claim 1, wherein the distance d1 between the annular bead and the sliding surface is less than 0.4 mm.

6. The composite piston according to claim 1, wherein the distance d1 between the annular bead and the sliding surface is less than 0.3 mm.

7. The composite piston according to claim 1, wherein at least one axial gap is provided in the annular bead.

8. The composite piston according to claim 1, wherein a plurality of axial gaps distributed over a circumference of the annular bead is provided in the annular bead.

9. The composite piston according to claim 7, wherein a ratio of a circumferential length s1 of the at least one axial gap to the circumferential length w1 of the annular bead is in the range of 1:1 to 1:20.

10. The composite piston according to claim 7, wherein a ratio of a circumferential length s1 of the at least one axial gap to the circumferential length w1 of the annular bead is in the range of 1:5 to 1:10.

11. The composite piston according to claim 1, wherein the axial length L1 of the annular bead is greater than or equal to 1 mm.

12. The composite piston according to claim 1, wherein the axial length L1 of the annular bead is less than or equal to 10 mm.

13. The composite piston according to claim 1, wherein the annular bead comprises a cylindrical contact surface for interacting with the cylindrical sliding surface.

14. The composite piston according to claim 1, wherein the sealing lip is adapted to have a high pressure side and a low pressure side upon sealing with the cylindrical sliding surface, wherein the annular bead is located on the low pressure side of the sealing lip.

15. The composite piston according to claim 1, wherein a distance l1 between the sealing lip and the annular bead is less than or equal to 10 mm.

16. The composite piston according to claim 1, wherein a distance l1 between the sealing lip and the annular bead is less than or equal to 4 mm.

17. The composite piston according to claim 1, wherein the annular bead has a sinusoidal shape along a circumference of the annular bead.

18. The composite piston according to claim 2, wherein the elastomer annular seal is vulcanized to the support body.

19. The composite piston according to claim 2, wherein all of the at least one annular seal are formed by a uniform elastomer layer.

20. The composite piston according to claim 1, wherein the support body is made of metal.

21. The composite piston according to claim 1, wherein the support body has a U-shape cross section.

22. The composite piston according to claim 1, wherein the at least one annular seal comprises a radially outer annular seal and a radially inner annular seal.

23. The composite piston according to claim 1, wherein the composite piston and component forming the cylindrical sliding surface rotate with respect to each other.

24. The composite piston according to claim 1, wherein the composite piston and component forming the cylindrical sliding surface do not rotate with respect to each other.

25. A motor vehicle transmission, comprising;
a composite piston; and
a component forming a cylindrical sliding surface for the composite piston, wherein the composite piston comprises:
a support body; and
at least one annular seal having a sealing lip interacting in a sealing manner with the cylindrical sliding surface, wherein the composite piston can be displaced translationally relative to the cylindrical sliding surface, wherein the annular seal comprises an annular bead displaced axially relative to the sealing lip and arranged to have a distance d1 from the sliding surface in a non-loaded state, where d1 is greater than or equal to zero.

26. The motor vehicle transmission according to claim 25, wherein each of the at least one annular seal is rotationally symmetric.

27. The motor vehicle transmission according to claim 25, wherein the sealing lip is an elastomer sealing lip, wherein the annular bead is an elastomer annular bead.
